(19) United States
(12) Patent Application Publication
(10) Pub. No.: US 2012/0159794 A1
(43) Pub. Date: Jun. 28, 2012

(54) Interchangeable Flatware Handles

(75) Inventor: Warren Vogel, Marlboro, NJ (US)

(73) Assignee: METRO DESIGN USA, Marlboro, NJ (US)

(21) Appl. No.: 13/272,372

(22) Filed: Oct. 13, 2011

Related U.S. Application Data
(60) Provisional application No. 61/392,543, filed on Oct. 13, 2010.

(51) Int. Cl. A47G 21/06; B25G 3/12

(52) U.S. Cl. 30/340

(57) ABSTRACT

A flatware with interchangeable elements, generally including a handle having a bore and a first engagement means and a working end comprising a tool end, a shaft and a second engagement means configured to detachably engage with the first engagement means. The interchangeable elements allow a consumer to change the appearance and purpose of the flatware quickly and conveniently. The flatware herein described also eliminates the need for maintaining multiple sets of flatware as the interchangeable elements allow for multiple design and utility combinations to be achieved with a single set of flatware.

### CROSS-REFERENCE TO RELATED APPLICATIONS

The present application claims the benefit of U.S. Provisional Patent Application No. 61/392,543, filed Oct. 13, 2010, the entire disclosure of which is incorporated herein by reference.

### FIELD OF THE INVENTION

The invention relates generally to flatware and more particularly to devices for providing flatware with interchangeable handles.

### BACKGROUND

Flatware generally includes a handle and a working end extending therefrom. The working end is the portion of the flatware used for cutting or otherwise manipulating food. Some flatware is made from a single piece of material such as aluminum or stainless steel. Other types of flatware include a handle component which is formed of material different from the working end. Such handles may be formed of wood, plastic, ceramic, and other materials. In such cases, the handle is typically formed by a process, then permanently attached to the flatware.

It is often desirable for flatware to have a decorative nature, so that it will be aesthetically pleasing when it is used in conjunction with a particular table setting, room décor or occasion. It is desirable for some to have their flatware match their plates, table linens, holiday theme, or the like. Unfortunately, it is not always possible for a single flatware set to match every occasion or table setting. In such cases individuals must obtain multiple sets of flatware, each having a different decorative appearance. Not only is this an expensive undertaking, but it requires storage of a significant number of flatware sets.

Moreover, flatware handles must be sturdy, so that the handle does not separate or break away from the working end.

Thus there is a need in the art for an inexpensive alternative to maintaining multiple sets of flatware, wherein such flatware is of a sturdy construction.

### SUMMARY OF THE INVENTION

In accordance with one embodiment of the present invention, flatware having interchangeable handles is provided. The interchangeable flatware handles disclosed herein solve the problem of maintaining multiple sets of flatware, allowing the consumer to save money, reduce the need to store flatware, and foster creativity in the home. The interchangeable handles disclosed herein allow the consumer to conveniently and economically have a variety of flatware handles so that they can add desirable designs to their everyday flatware and simply interchange it for a special occasion, holiday, and/or to match their linens and place settings.

In one aspect, flatware as disclosed herein includes a handle operable to be detached and reattached to a working end of a flatware piece. The handle may have any desired external design and may be fabricated of any suitable material. The handle may be made of any suitable size. In one embodiment the handle is sized for adults. In another embodiment the handle is sized for children.

In one embodiment, a flatware device having interchangeable elements is disclosed, having a handle including a bore and a first engagement means and a working end having a tool end, a shaft and a second engagement means configured to detachably engage with said first engagement means. As will be apparent to the skilled artisan, the engagement means and corresponding engagement means may be reversed.

In one embodiment, the shaft of the working end is configured to be removably inserted into the bore of the handle.

In one embodiment, one of said first engagement means and second engagement means is a push-button comprising a latch and the other comprises an aperture for receiving said latch.

In another embodiment, one of the first engagement means is a magnet and the second engagement means is an element magnetically engageable to the first magnet.

In another embodiment, the first engagement means is a first detent and said second engagement means is a second detent.

In another embodiment, one of the first engagement means and second engagement means is a male twist-lock component and the other is a female twist-lock component.

In one embodiment, the shaft of the working end further includes a collar configured to abut the handle.

In one embodiment, a set of flatware devices and interchangeable elements may be provided. The set of flatware devices and interchangeable elements having a plurality of handles, each handle having a bore and an engagement means. The set of flatware devices and interchangeable elements also comprises a plurality of working ends, each working end including a tool end, a shaft and an engagement means configured to detachably engage the engagement means of the handle. Each one of the working ends is capable of use with any of the handles.

In one embodiment, a device for detaching interchangeable components from compatible flatware devices is provided. The device includes a body having a recess and a tab situated in the recess. The recess is configured to receive a handle of a flatware device and the tab is configured to depress an engagement means located on the flatware device in order to allow a working end of the flatware device to be released.

The objects of the present invention will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a perspective view of a flatware device in accordance with an embodiment of the present invention;

FIG. 2 is a perspective view of a flatware device handle disengaged from a working end in accordance with an embodiment of the present invention;

FIG. 2A is a perspective view of a working end disengaged from a flatware device handle in accordance with an embodiment of the present invention;

FIG. 2B is a front end view of a handle, in accordance with an embodiment of the present invention;

FIG. 3 is a cross-sectional view of a handle portion and working end in accordance with an embodiment of the present disclosure;

FIG. 3A is a cross-sectional view of a handle portion and working end in accordance with an embodiment of the present disclosure;

FIG. 3B is a cross-sectional view of a handle portion and working end in accordance with an embodiment of the present disclosure;

FIG. 4 is a perspective view of a handle portion with an open lower end in accordance with an embodiment of the present invention;

FIG. 4A is a perspective view of a closure device in accordance with an embodiment of the present invention;

FIG. 4B provides a perspective view of an engagement means in accordance with an embodiment of the present invention.

FIG. 4C is a cross-sectional view of a flatware device handle and working end in accordance with an embodiment of the present invention;

FIG. 4D is a cross-sectional view of a flatware device handle disengaged from a working end in accordance with an embodiment of the present invention;

FIG. 4E is a cross-sectional view of a flatware device handle with an engagement means in a disengaged position and with a working end partially removed from the flatware device handle;

FIG. 5 is an perspective view of a handle removal tool in accordance with an embodiment of the present invention;

FIG. 6 is a top plan view of a spoon shaped flatware device working end disengaged from the handle portion in accordance with an embodiment of the present invention; and

FIG. 6A is a top plan view of a knife shaped flatware device working end disengaged from the handle portion in accordance with an embodiment of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearance of the phase “in an embodiment” in various places in the specification are not necessarily all referring to the same embodiment.

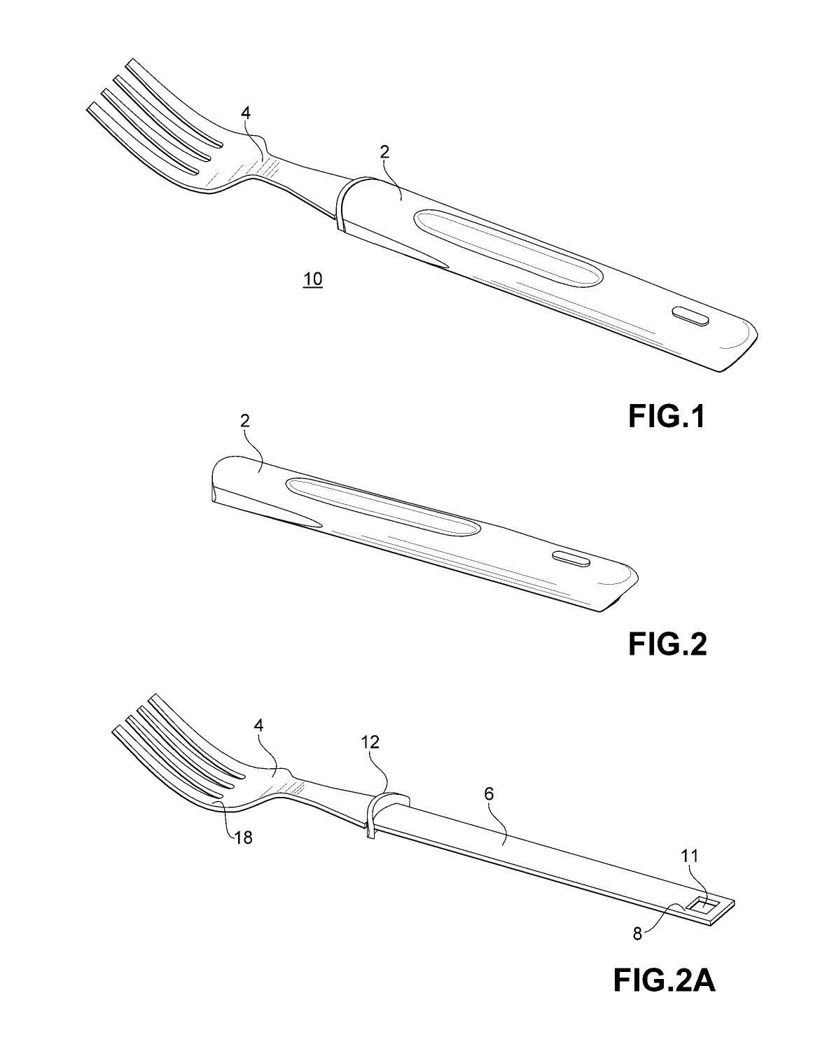

Now referring to FIG. 1, flatware 10 as disclosed herein includes a handle 2 operable to be detached and reattached to a working end 4 of a flatware piece. The handle 2 may have any desired external design and may be fabricated of any suitable material. Suitable external designs include, but are not limited to, flat, rounded and cylindrical. Suitable materials include, but are not limited to, plastics, ceramics, metals (e.g., stainless steel), precious metals (e.g., silver), wood and polymers. The handle 2 may be made of any suitable size. In one embodiment the handle 2 is sized for adults. In another embodiment the handle 2 is sized for children. One of ordinary skill in the art would appreciate that there are numerous sizes, shapes and materials that could be utilized with a handle in accordance with embodiments of the present invention, and embodiments of the present invention are contemplated for use with handles of any size, shape and/or material.

Similarly, according to embodiments of the present invention, the working end 4 can be of any suitable material, size and/or design. For instance, a working end 4 could be constructed from plastics, metals, precious metals, woods and/or polymers. A working end 4 could be designed in particular for use by adults, use by children or any combination thereof. One of ordinary skill in the art would appreciate that there are numerous sizes, shapes and materials that could be utilized with a working end in accordance with embodiments of the present invention, and embodiments of the present invention are contemplated for use with working ends of any size, shape and/or material.

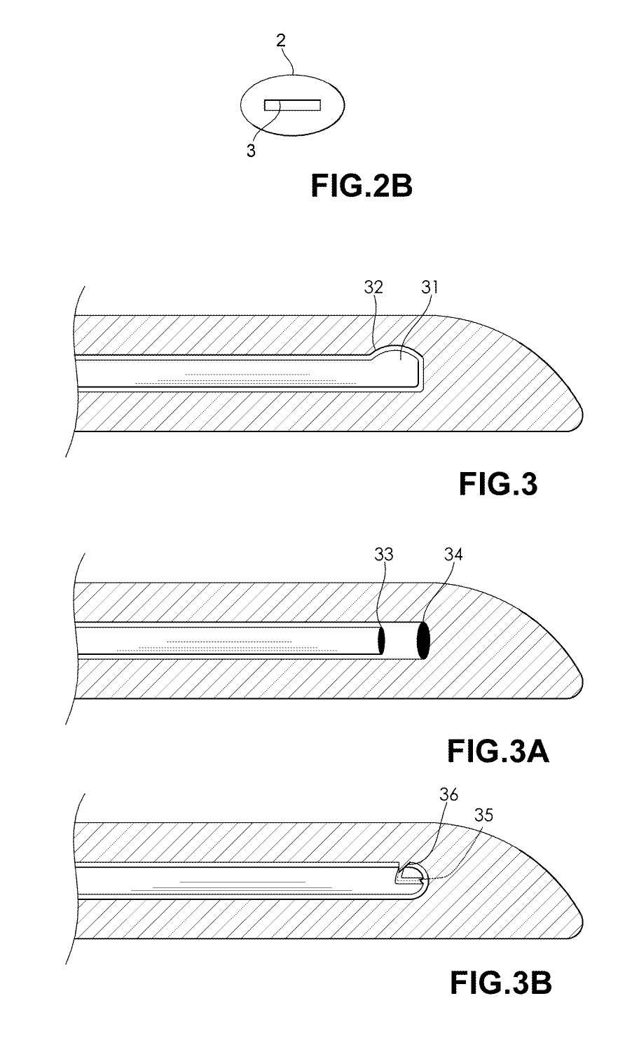

Now referring to FIGS. 2-2B, flatware 10 includes a working end 4. The working end 4 includes a shaft 6 having an end 8 releasably connectable to the handle 2 and a tool end 18 which includes the fork, spoon, knife or other working portion of the flatware 10. The end 8 may include any suitable engagement element 11 such as an aperture operable to releasably connect to a corresponding engagement element in or on handle 2. The shaft 6 may include a collar or cap 12 operable to abut a handle end and which may serve as a stop to limit the insertion of the shaft 6 in the handle 2, and which may prevent debris from collecting between the working end 4 and the handle 2.

In one embodiment the flatware handle 2 includes a bore 3 for receiving a shaft 6 of a working end 4 of a flatware piece 10. The respective engagement elements of the handle 2 and end 8 may include, but are not limited to, an interior catch, detent or other means.

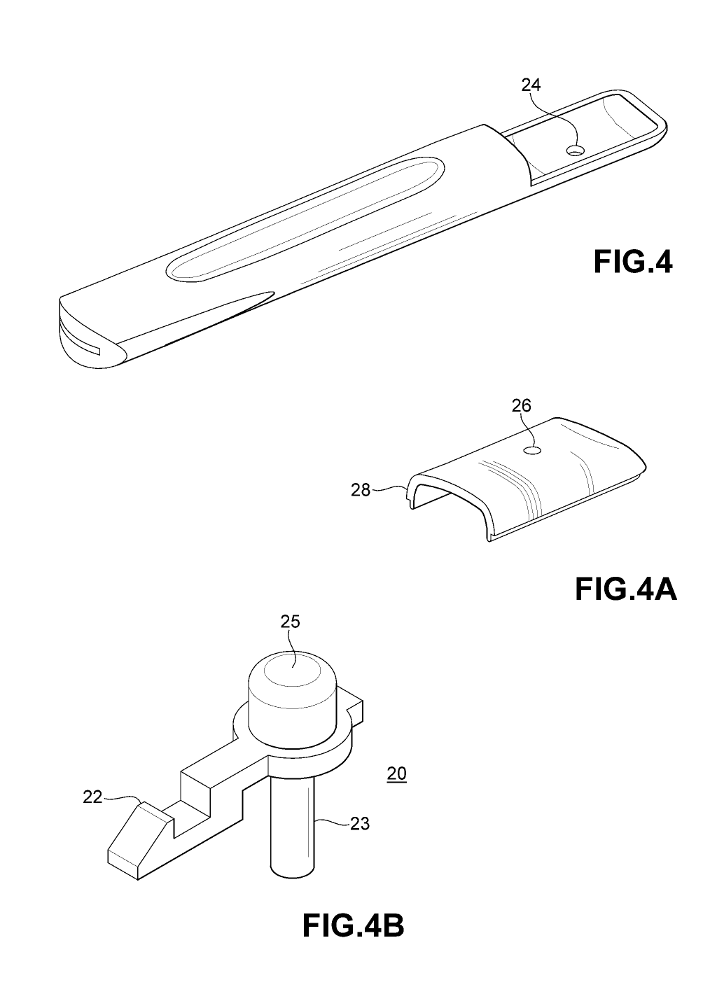

Now referring to FIG. 3, in one embodiment the engagement element 11 comprises a lip 31 and handle 2 comprises an engagement element comprising a detent 32. Preferably, lip 31 is rounded in profile so that it provides a secure but releasable engagement with detent 32.

Now referring to FIG. 3A, in one embodiment the engagement element 11 comprises a magnet 33 and handle 2 comprises an engagement element comprising a magnetic element 34 magnetically engageable to the magnet 33. Preferably, the magnet 34 and the magnetic element 36 are configured such that they attract one another, providing a secure but releasable engagement.

Now referring to FIG. 3B, in one embodiment the engagement element 11 comprises a female twist-lock element 35 and handle 2 comprises an engagement element comprising a male twist-lock element 36. In this embodiment, female twist-lock element 35 is inserted onto and received on and twisted upon male twist-lock element 36 so that it provides a secure but releasable engagement. One of ordinary skill in the art will appreciate that there are numerous twist-lock engagement means that could be utilized with embodiments of the present invention. For instance, an exemplary embodiment of a twist-lock engagement means may be comprised of a male twist-lock element with one or more pins extruding outwardly and a compatible female twist-lock element with one or more channels for receiving said one or more pins. The channels are commonly formed in a curved manner, such as a “J” shape or “U” shape, such that once the engagement means are fully engaged, the only way to disengage the engagement means is to push inward and rotate the male twist-lock element out of the channel of the female twist-lock element.

As will be apparent to the skilled artisan, the respective engagement elements of the shaft 6 and the handle 2 may be reversed. One of ordinary skill in the art would appreciate that there are numerous engagement means that could be utilized with embodiments of the present invention, and embodiments of the present invention are contemplated for use with any type of engagement means.

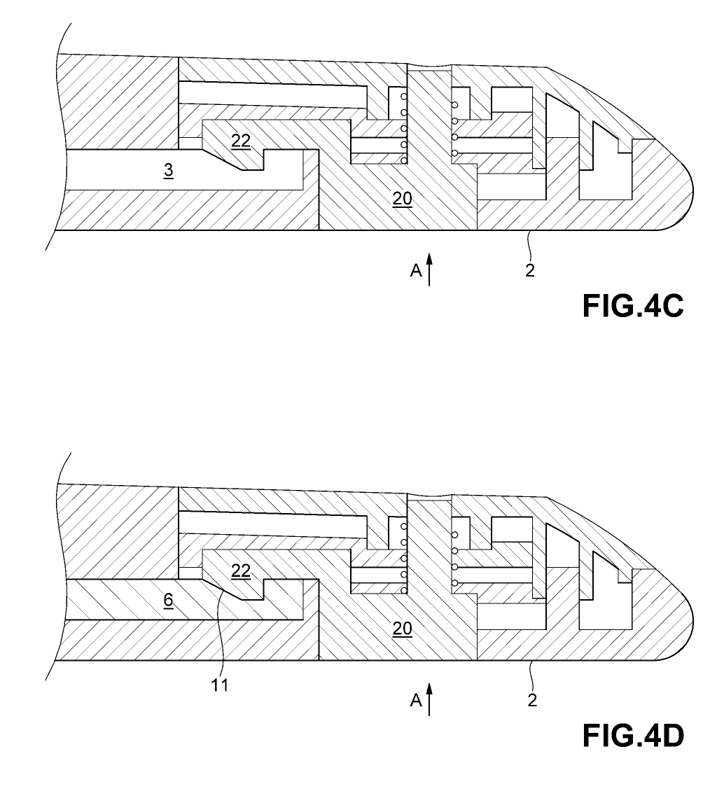

Now referring to FIGS. 4-4E, an exemplary embodiment of a push-button engagement means is provided. Referring specifically to to FIGS. 4-4B, structural details relating to a push-button engagement means are provided. FIG. 4 depicts a portion of the flatware handle which is operably connected to the push-button 20 depicted in FIG. 4B and the closure device 28 in FIG. 4A.

When fully assembled, a top post 25 of a push-button 20 extends through an opening 26 in a closure device 28 (shown in FIG. 4A). The handle portion shown in FIG. 4 has a bottom opening 24 configured to receive a bottom post 23 of the engagement means 20 when the flatware device is fully assembled. In this configuration, the push-button 20 is fixed in place and capable of engaging an aperture 11 of a working end 4 upon its latch 22.

Turning now specifically to FIGS. 4C-4E, cross-sectional views of the exemplary embodiment push-button engagement means are provided. The push-button engagement means 20 is operably engaged to a latch mechanism 22 in the handle 2. The shaft 6 of the working end 4 includes an aperture 11 formed therein for engaging the latch mechanism 22. Upon insertion of the shaft 6 in the bore 3, the end of the shaft 6 urges the latch mechanism 22 upward and as the shaft 6 continues into the bore 3, the latch mechanism 22 securely engages the aperture 11, preventing disengagement of the working end 4 from the handle 2. Upon depressing the push-button 20 in the direction A, the latch mechanism 22 disengages from the aperture 11 (as shown in FIG. 4E), permitting removal of the handle 2 from the working end 4. The push-button and latch may be formed of any suitable material such as a metal, alloy, ceramic or the like.

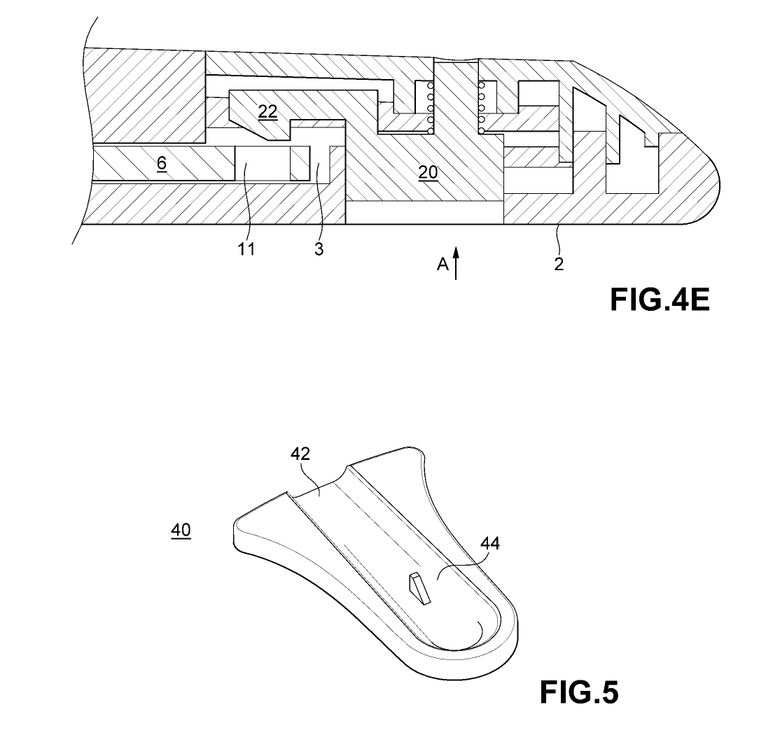

Now referring to FIG. 5, a handle removal tool 40 is provided including a recess 42 for engaging the handle portion and a peg 44 located in the recess 40 for depressing the push-button 20. Placement of the handle 2 into the recess 42 aligns the peg 44 with the push-button 20, releasing the latch and permitting a user to change handles easily. The handle removal tool 40 facilitates insertion of a new working end 4 by holding the handle 2 firmly while the working end 4 is being inserted.

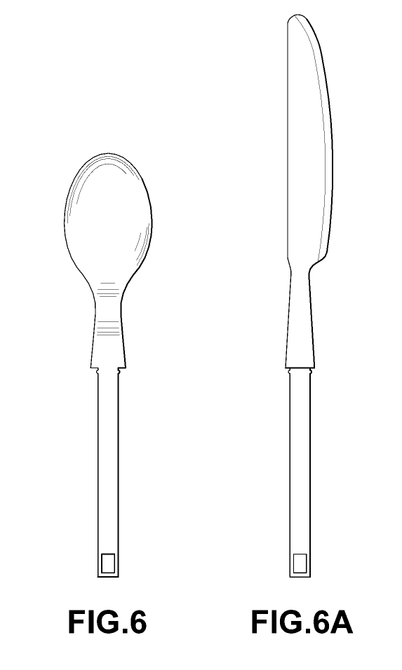

Now referring to FIGS. 6 and 6A, exemplary embodiments of working ends are provided comprising a spoon working end and a knife working end. It will be understood to those skilled in the art the dimensions and shape of the working end may be varied.

In a further embodiment, the invention comprises a set of handles all having the same size. In another embodiment, a set of handles is provided which are of varying sizes. In another embodiment, a set of handles of graduated sizes is provided, wherein the interchangeable handles may be used as a training device for young children, so that as a child is learning to use flatware the handles can be changed to suit the level of skill of the child and/or the size of the child's hands.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A flatware device having interchangeable elements, comprising:
a handle comprising a bore and a first engagement means; and
a working end comprising a tool end, a shaft and a second engagement means configured to detachably engage said first engagement means.

2. The flatware device of claim 1, wherein said shaft is configured to be removably inserted into said bore.

3. The flatware device of claim 1, wherein one of said first engagement means and second engagement means is a push-button comprising a latch and the other comprises an aperture for receiving said latch.

4. The flatware device of claim 1, wherein one of said first engagement means is a first magnet and said second engagement means is an element magnetically engageable to the first magnet.

5. The flatware device of claim 1, wherein said first engagement means is a first detent and said second engagement means is a second detent.

6. The flatware device of claim 1, wherein one of said first engagement means and second engagement means is a male twist-lock component and the other comprises a female twist-lock component.

7. The flatware device of claim 1, wherein said shaft further comprises a collar configured to abut a face of said handle located at one end of said bore.

8. A set of flatware devices and interchangeable elements, comprising:
a plurality of handles, each handle comprising a bore and a first engagement means; and
a plurality of working ends, each working end comprising a tool end, a shaft and a second engagement means configured to detachably engage with said first engagement means,
wherein each of said working ends is capable of use with any of said handles.

9. The set of flatware devices of claim 9, wherein at least one of said shafts is configured to be removably inserted into one of said bores.

10. The set of flatware devices of claim 9, wherein at least one of said first engagement means and at least one of said second engagement means is a push-button comprising a latch and the other comprises an aperture for receiving said latch.

11. The set flatware devices of claim 9, wherein at least one of said first engagement means is a first magnet and at least one of said second engagement means is a second magnet.

12. The set of flatware devices of claim 9, wherein at least one of said first engagement means is a first detent and at least one of said second engagement means is a second detent.

13. The set of flatware devices of claim 9, wherein at least one of one of said first engagement means and at least one of second engagement means is a male twist-lock component and the other comprises a female twist-lock component.

14. The set of flatware devices of claim 9, wherein each one of said shafts is further comprised of a collar configured to abut a face of each one of said handles located at one end of said bore.

15. A device for detaching interchangeable components from compatible flatware devices, comprising:
a body comprising a recess; and
a tab situated in said recess,
wherein said recess is configured to receive a handle of a flatware device and said tab is configured to depress an engagement means located on said flatware device in order to allow a working end of said flatware device to be released.
